(19) United States
(12) Patent Application Publication
(10) Pub. No.: US 2026/0336813 A1
(43) Pub. Date: Oct. 29, 2026

(54) AERONAUTICAL PROPULSION SYSTEM ASSEMBLY

(71) Applicant: SAFRAN AIRCRAFT ENGINES, Paris (FR)

(72) Inventors: Didier René André ESCURE, MOISSY-CRAMAYEL (FR); Baptiste Dorian LAWNICZEK, MOISSY-CRAMAYEL (FR)

(73) Assignee: SAFRAN AIRCRAFT ENGINES, Paris (FR)

(21) Appl. No.: 19/567,650

(22) Filed: Mar. 16, 2026

(30) Foreign Application Priority Data
Mar. 19, 2025 (FR) FR 2502827

(51) Int. Cl. B64D 27/10; F01D 25/24; F01D 25/30

(52) U.S. Cl. CPC B64D 27/10; F01D 25/24; F01D 25/30

(57) ABSTRACT

An assembly of an aeronautical propulsion system includes a low-pressure turbine having an annular casing and rotor wheels. Each rotor wheel includes a disk and turbine blades extending radially between the disk and casing. Each blade includes a base connected to the disk, a platform extending transversely to the base, and an airfoil extending from the platform to a free end having a root with an inner surface delimiting a flowpath portion. The assembly further includes a high-pressure turbine that drives a high-pressure compressor, and an exhaust casing supporting a downstream portion of a low-pressure shaft. The low-pressure turbine is positioned axially between the high-pressure turbine and exhaust casing. The low-pressure turbine disks are interconnected, with a driving disk that drives both the rotor wheels and a fan section rotor. The assembly satisfies a defined relationship between outlet section area, inlet temperature, number of rotor wheels, and outer radii.

### TECHNICAL FIELD

The present disclosure falls within the aeronautical field. More specifically, the present disclosure relates to the dimensioning of the turbine section of an aeronautical engine.

### STATE OF THE ART

Reducing the weight and volume of an aeronautical engine in order to improve its fuel consumption without reducing its performance or safety is a key issue in the aeronautical field. However, these reductions must not be obtained at the expense of ease of maintenance or production cost of the engine.

### SUMMARY OF THE DISCLOSURE

One object of the present disclosure is to reduce the weight and volume of an aeronautical engine, while improving its production cost and ease of maintenance.

In this regard, an assembly for an aeronautical propulsion system is proposed according to one aspect of the present disclosure, comprising:
a low-pressure turbine comprising a plurality of low-pressure rotor wheels and an annular low-pressure casing centered on a longitudinal axis, wherein each low-pressure rotor wheel of the plurality of low-pressure rotor wheels comprises:
   a low-pressure disk centered on the longitudinal axis, wherein the low-pressure disks of the plurality of low-pressure rotor wheels are connected together, and a low-pressure drive disk driving the plurality of low-pressure rotor wheels is configured to be connected to a low-pressure shaft of the aeronautical propulsion system extending along the longitudinal axis to drive in rotation a rotor of a fan section of the aeronautical propulsion system; and
   a plurality of low-pressure blades, each low-pressure blade of the plurality of low-pressure blades extending radially between the low-pressure disk and the low-pressure casing, and comprising:
      a base connected to the low-pressure disk and which extends radially with respect to a periphery of the low-pressure disk;
      a platform which extends transversely to the base; and
      an airfoil which extends radially from the platform to a free end radially opposite to the base, wherein the free end of the airfoil comprises a root that has an inner surface delimiting, with the platform, a portion of a flowpath, wherein the airfoil extends in the flowpath and has a leading edge intended to face a fluid circulating within the flowpath, and a trailing edge axially opposite to the leading edge;
a high-pressure turbine comprising at least one high-pressure turbine rotor wheel configured to drive in rotation at least one high-pressure rotor wheel of a high-pressure compressor of the aeronautical propulsion system via a high-pressure shaft of the aeronautical propulsion system extending along the longitudinal axis; and
an exhaust casing configured to support in rotation the low-pressure shaft via a bearing of the aeronautical propulsion system;
wherein the low-pressure turbine is positioned axially between the high-pressure turbine and the exhaust casing; and
wherein:

$$γ \leq \frac{S * {T}^{4}}{N * {R}_{m}^{2} * 1 {0}^{9}} \leq δ$$

where:
γ is equal to 2,600 K⁴;
S is an outlet section of the low-pressure turbine defined as an area of an outlet surface taken in a plane orthogonal to the longitudinal axis which is positioned equidistant from the leading edge and from the trailing edge of an airfoil of a low-pressure rotor wheel which is disposed axially facing the exhaust casing, the outlet surface being radially delimited, on the one hand, by an annular surface defined by the set of inner surfaces of the roots that delimit a portion of a flowpath of the low-pressure rotor wheel which is disposed axially facing the exhaust casing and, on the other hand, by another annular surface that delimits the portion of a flowpath and which is formed by each of the platforms of the low-pressure rotor wheel which is disposed axially facing the exhaust casing, S being greater than or equal to 0.35 m² and less than or equal to 0.60 m²;
T is a temperature intended to be reached by the fluid entering the low-pressure turbine when the aeronautical propulsion system is operating at maximum continuous power, T being measured in a plane orthogonal to the longitudinal axis that comprises the leading edge of an airfoil of one of the plurality of low-pressure rotor wheels which is disposed axially facing the high-pressure turbine, T being greater than or equal to 1,223 K and less than or equal to 1,473 K;
N is the number of the plurality of low-pressure rotor wheels, N being greater than or equal to 2 and less than or equal to 5;

$${R}_{m} = {\sum }_{i = 1}^{N} \frac{{R}_{i}}{N} ,$$

where Rᵢ is an outer radius of the i^{th} of the plurality of low-pressure rotor wheels, Rᵢ being defined in a plane orthogonal to the longitudinal axis which is positioned equidistant from the leading edge and from the trailing edge of the airfoil of one of the plurality of low-pressure blades of the i^{th} of the plurality of low-pressure rotor wheels, Rᵢ being a distance between the longitudinal axis and a free end of the root, and Rₘ being greater than or equal to 0.2 m and less than or equal to 0.6 m; and δ is equal to 3,500 m²·K⁴.

The assembly may be such that:

$$α \leq \frac{S * {T}^{4}}{Z * 1 {0}^{6}} \leq β$$

where:
α is equal to 5,700 m²·K⁴;
Z is the total number of low-pressure blades of the plurality of low-pressure rotor wheels, Z being greater than or equal to 150 and less than or equal to 300; and
β is equal to 7,000 m²·K⁴.

The high-pressure turbine may comprise an annular high-pressure casing centered on the longitudinal axis; and
the at least one high-pressure turbine rotor wheel may comprise:
   a high-pressure disk centered on the longitudinal axis; and
   a plurality of high-pressure blades, each high-pressure blade of the plurality of high-pressure blades extending radially between the high-pressure disk and the high-pressure casing; and
the assembly then being such that:

$$θ \leq \frac{Z}{Y} \leq μ$$

where:
θ is equal to 1.4;
Z is the total number of low-pressure blades of the plurality of low-pressure rotor wheels, Z being greater than or equal to 150 and less than or equal to 300;
Y is the total number of high-pressure blades of the at least one high-pressure turbine rotor wheel, Y being greater than or equal to 80 and less than or equal to 180; and
μ is equal to 2.5.

The assembly may further comprise:
a combustion chamber configured to ignite a fluid derived from the high-pressure compressor; and a low-pressure shaft extending along the longitudinal axis, connected to the low-pressure drive disk driving the plurality of low-pressure rotor wheels, and configured to drive the rotor of the fan section of the aeronautical propulsion system.

According to another aspect of the present disclosure, an aeronautical propulsion system is proposed, comprising:
an assembly according to the present disclosure;
a fan section comprising a rotor; a low-pressure shaft extending along the longitudinal axis and connecting the rotor of the fan section to the low-pressure drive disk driving the plurality of low-pressure rotor wheels of the low-pressure turbine of the assembly; a high-pressure compressor comprising at least one high-pressure rotor wheel; a high-pressure shaft extending along the longitudinal axis and connecting the at least one high-pressure rotor wheel of the high-pressure compressor to the at least one high-pressure turbine rotor wheel of the high-pressure turbine of the assembly; and a bearing supporting in rotation the low-pressure shaft and connected to the exhaust casing of the assembly.

According to another aspect of the present disclosure, a method for manufacturing an aeronautical propulsion system is proposed, comprising:
a low-pressure turbine comprising a plurality of low-pressure rotor wheels and an annular low-pressure casing centered on a longitudinal axis, wherein each low-pressure rotor wheel of the plurality of low-pressure rotor wheels comprises:
   a low-pressure disk centered on the longitudinal axis, wherein the low-pressure disks of the plurality of low-pressure rotor wheels are connected together, and a low-pressure drive disk driving the plurality of low-pressure rotor wheels is configured to be connected to a low-pressure shaft of the aeronautical propulsion system extending along the longitudinal axis to drive in rotation a rotor of a fan section of the aeronautical propulsion system; and
   a plurality of low-pressure blades, each low-pressure blade of the plurality of low-pressure blades extending radially between the low-pressure disk and the low-pressure casing, and comprising:
      a base connected to the low-pressure disk and which extends radially with respect to a periphery of the low-pressure disk;
      a platform which extends transversely to the base; and
      an airfoil which extends radially from the platform to a free end radially opposite to the base, wherein the free end of the airfoil comprises a root that has an inner surface delimiting, with the platform, a portion of a flowpath, wherein the airfoil extends in the flowpath and has a leading edge intended to face a fluid circulating within the flowpath, and a trailing edge axially opposite to the leading edge;
a high-pressure turbine comprising at least one high-pressure turbine rotor wheel configured to drive in rotation at least one high-pressure rotor wheel of a high-pressure compressor of the aeronautical propulsion system via a high-pressure shaft of the aeronautical propulsion system extending along the longitudinal axis; and
an exhaust casing configured to support in rotation the low-pressure shaft via a bearing of the aeronautical propulsion system;
wherein the low-pressure turbine is positioned axially between the high-pressure turbine and the exhaust casing; and
the manufacturing method comprising a step of dimensioning the low-pressure turbine so that:

$$γ \leq \frac{S * {T}^{4}}{N * {R}_{m}^{2} * 1 {0}^{9}} \leq δ$$

where:
γ is equal to 2,600 K⁴;
S is an outlet section of the low-pressure turbine defined as an area of an outlet surface taken in a plane orthogonal to the longitudinal axis which is positioned equidistant from the leading edge and from the trailing edge of an airfoil of a low-pressure rotor wheel which is disposed axially facing the exhaust casing, the outlet surface being radially delimited, on the one hand, by an annular surface defined by the set of inner surfaces of the roots that delimit a portion of a flowpath of the low-pressure rotor wheel which is disposed axially facing the exhaust casing and, on the other hand, by another annular surface that delimits the portion of a flowpath and which is formed by each of the platforms of the low-pressure rotor wheel which is disposed axially facing the exhaust casing, S being greater than or equal to 0.35 m² and less than or equal to 0.60 m²;
T is a temperature intended to be reached by the fluid entering the low-pressure turbine when the aeronautical propulsion system is operating at maximum continuous power, T being measured in a plane orthogonal to the longitudinal axis that comprises the leading edge of an airfoil of one of the plurality of low-pressure rotor wheels which is disposed axially facing the high-pressure turbine, T being greater than or equal to 1,223 K and less than or equal to 1,473 K;
N is the number of the plurality of low-pressure rotor wheels, N being greater than or equal to 2 and less than or equal to 5;

$${R}_{m} = {\sum }_{i = 1}^{N} \frac{{R}_{i}}{N} ,$$

where Rᵢ is an outer radius of the i^{th} of the plurality of Low-pressure rotor wheels, Rᵢ being defined in a plane orthogonal to the longitudinal axis which is positioned equidistant from the leading edge and from the trailing edge of the airfoil of one of the plurality of low-pressure blades of the i^{th} of the plurality of low-pressure rotor wheels, Rᵢ being a distance between the longitudinal axis and a free end of the root, and Rₘ being greater than or equal to 0.2 m and less than or equal to 0.6 m; and
δ is equal to 3,500 m²·K⁴.

The dimensioning of the low-pressure turbine may further be implemented so that:

$$α \leq \frac{S * {T}^{4}}{Z * 1 {0}^{6}} \leq β$$

where:
α is equal to 5,700 m²·K⁴;
Z is the total number of low-pressure blades of the plurality of low-pressure rotor wheels, Z being greater than or equal to 150 and less than or equal to 300; and
β is equal to 7,000 m²·K⁴.

The high-pressure turbine may comprise an annular high-pressure casing centered on the longitudinal axis; and
the at least one high-pressure turbine rotor wheel may comprise:
   a high-pressure disk centered on the longitudinal axis; and
   a plurality of high-pressure blades, each high-pressure blade of the plurality of high-pressure blades extending radially between the high-pressure disk and the high-pressure casing; and
the manufacturing method further comprises a step of dimensioning the high-pressure turbine, the dimensioning of the high-pressure turbine and the dimensioning of the low-pressure turbine being implemented so that:

$$θ \leq \frac{Z}{Y} \leq μ$$

where:
θ is equal to 1.4;
Z is the total number of low-pressure blades of the plurality of low-pressure rotor wheels, Z being greater than or equal to 150 and less than or equal to 300;
Y is the total number of high-pressure blades of the at least one high-pressure turbine rotor wheel, Y being greater than or equal to 80 and less than or equal to 180; and
μ is equal to 2.5.

### DESCRIPTION OF THE FIGURES

FIG. 1 schematically illustrates an aircraft equipped with an aeronautical propulsion system.

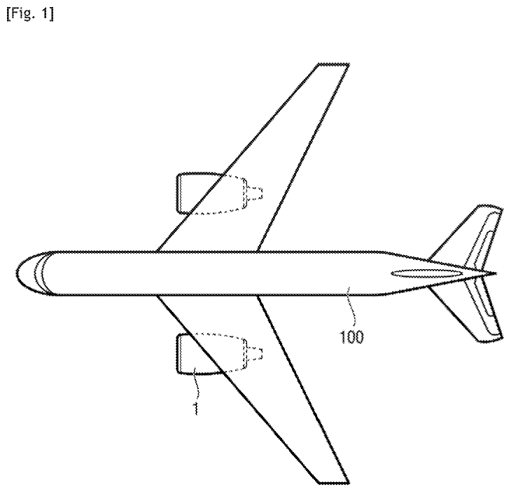

FIG. 2 is a schematic sectional view of one exemplary embodiment of an aeronautical propulsion system.

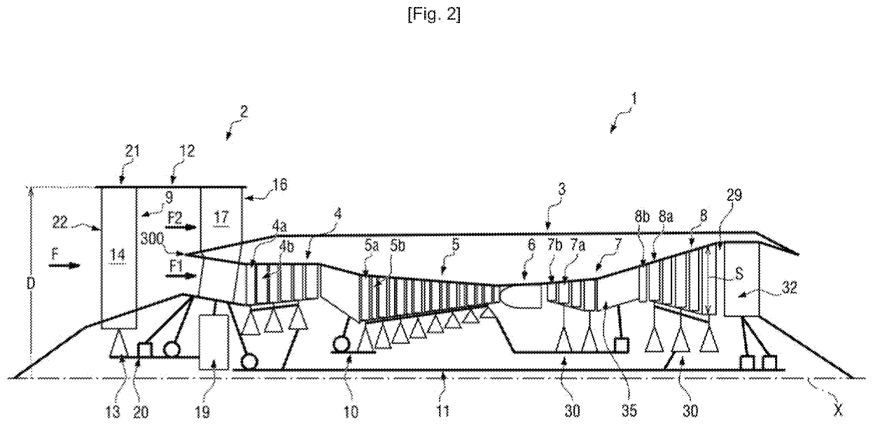

FIG. 3 is a schematic sectional view of another exemplary embodiment of an aeronautical propulsion system.

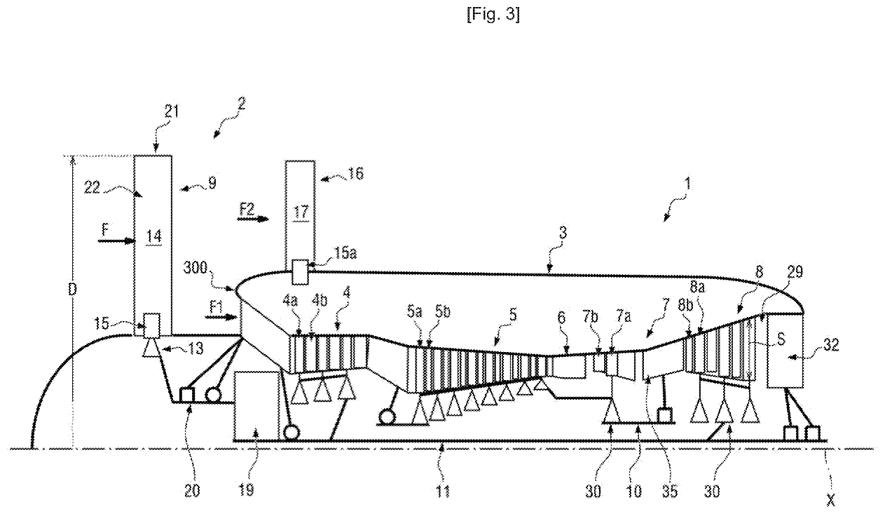

FIG. 4 is a schematic sectional view of one exemplary embodiment of a reduction mechanism.

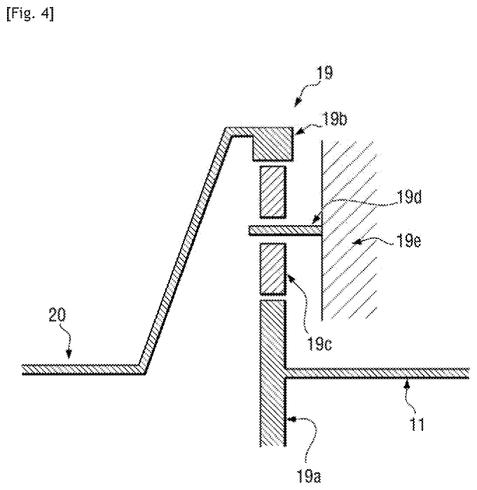

FIG. 5 is a schematic sectional view of another exemplary embodiment of a reduction mechanism.

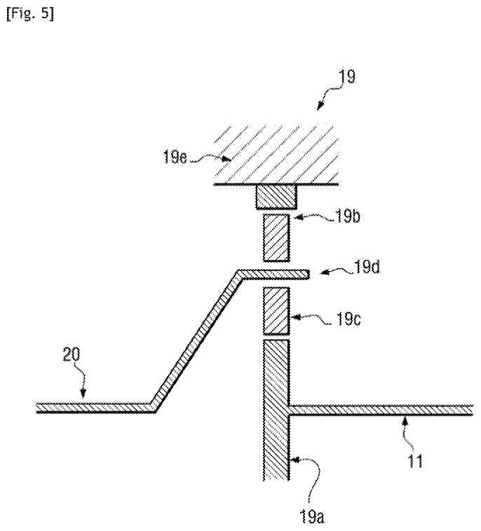

FIG. 6 is a schematic sectional view of part of a turbine section of an aeronautical propulsion system.

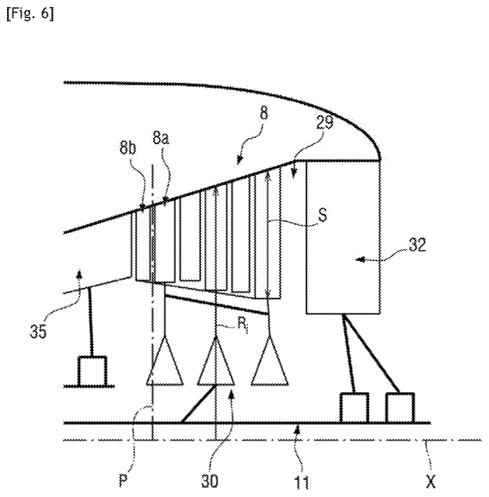

FIG. 7 is a schematic perspective view of a blade wheel of a turbine section of an aeronautical propulsion system.

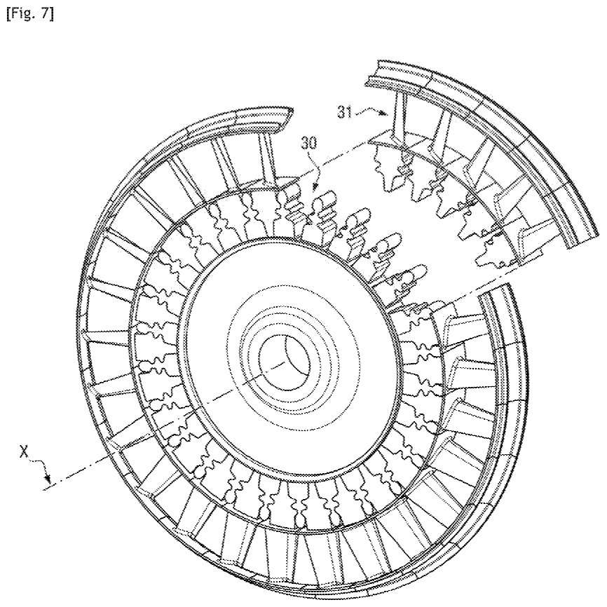

FIG. 8 is a schematic perspective view of a blade of a blade wheel of a turbine section of an aeronautical propulsion system.

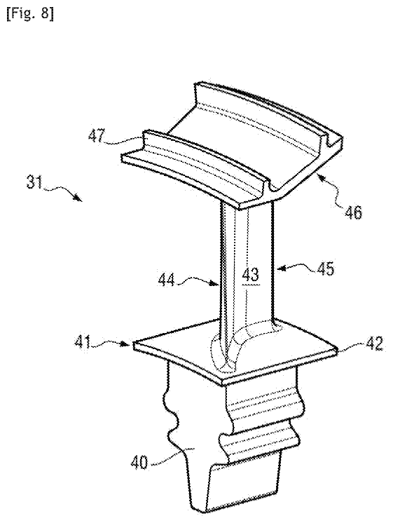

FIG. 9 is a schematic sectional view of part of a blade wheel of a turbine section of an aeronautical propulsion system.

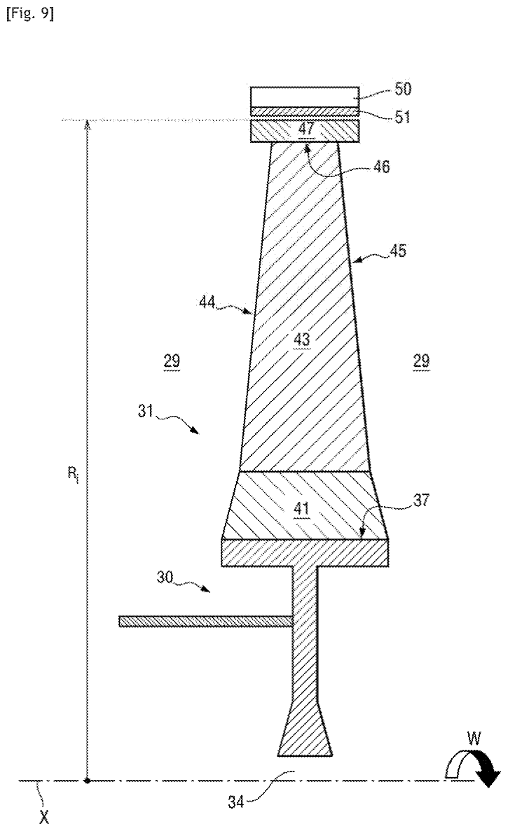

### DETAILED DESCRIPTION

### Aircraft

An aircraft 100 is an apparatus configured to rise and travel in the air and can for example be a civil or military airplane, or even a helicopter. An aircraft 100 comprises an airframe which, in the case of an airplane, is composed of a fuselage, of a wing configuration comprising two wings, of an empennage, of flight control surfaces and of a landing gear.

### Propulsion System

A propulsion system 1 has a main direction along a longitudinal axis X along which the propulsion system 1 extends. The propulsion system 1 is an aeronautical propulsion system 1 configured to be fixed to the airframe of the aircraft 100 by means of a pylon (or mast), which is fixed to the airframe of the aircraft 100.

In the present disclosure, an axial direction corresponds to the direction of the longitudinal axis X, and a radial direction is a direction perpendicular to the longitudinal axis X and passing through it. Moreover, a circumferential (or lateral, or tangential) direction corresponds to a direction perpendicular to the longitudinal axis X and not passing through it. Unless otherwise specified, the terms “inner” (or “internal”) and “outer” (or “external”), respectively, are used with reference to a radial direction such that the inner part or face of an element is closer to the longitudinal axis X than the outer part or face of the same element. In addition, the parameters (pressure, flow rate, thrust, speed, etc.) are systematically determined when the propulsion system 1 is stationary, uninstalled, in take-off rating in a standard atmosphere (as defined by the International Civil Aviation Organization (ICAO) manual, Doc 7488/3, 3^{rd} edition), and at sea level. By “Uninstalled” it is meant that the measurements are performed when the propulsion system 1 is in a test bench (and uninstalled on the aircraft 100), the measurements then being simpler to perform. Finally, the distances, or dimensions (length, width, radius, diameter, etc.), are measured at ambient temperature (about 20° C.) when the propulsion system 1 is cold, that is to say when the propulsion system 1 is at standstill for a sufficient period so that the pieces of the propulsion system 1 are at ambient temperature, it being understood that these dimensions vary little compared to the conditions under which the propulsion system 1 is in take-off rating.

The propulsion system 1 comprises a fan section 2 and a generator 3, often called “gas generator”. The generator 3 is centered on the longitudinal axis X and comprises, from upstream to downstream in the direction of flow of the gases in the propulsion system 1 when it is in operation, a compressor section 4, 5, a combustion chamber 6 and a turbine section 7, 8.

The fan section 2 comprises at least one rotor 9 specific to be driven in rotation, about the longitudinal axis X, relative to a stator part 19e of the propulsion system 1, by the generator 3. In this way, an air stream F is drawn into the propulsion system 1. Each rotor 9 comprises a hub 13 and blades 14 extending radially outwards from the hub 13. The blades 14 of each rotor 9 may be fixed relative to the hub 13, or have a variable setting. In this case, the base of the blades 14 of each rotor 9 is pivotally mounted following a setting axis and is connected to a pitch change mechanism 15 mounted in the propulsion system 1, the setting being adjusted according to the flight phases by the pitch change mechanism 15. The rotor 9 may comprise at least twelve blades 14 and at most twenty-four blades 14, preferably at least sixteen blades 14 and at most twenty-two blades 14. The diameter D of the rotor 9 is measured in a plane normal to the axis of rotation X of the rotor 9, at the level of an intersection between a tip 21 and a leading edge 22 of the blades 14 of the rotor 9. The diameter D may be greater than or equal to 1.0 meter and less than or equal to 5.0 meters, and may typically be greater than or equal to 80 inches (203.2 cm) and less than or equal to 185 inches (469.9 cm).

The fan section 2 may further comprise a stator 16, or straightener, which comprises vanes 17 mounted on a hub of the stator 16 and whose function is to straighten an air stream F2 that flows at the outlet of the rotor 9. The vanes 17 of the stator 16 may be fixed relative to the hub of the stator 16, or have a variable setting. Where applicable, and similarly to the blades 14 of the rotor 9, the base of the vanes 17 of the stator 16 is pivotally mounted following a setting axis and is connected to a pitch change mechanism 15a, which is generally distinct from that of the rotor 9, the setting being adjusted according to the flight phases by the pitch change mechanism 15a. The hub of the stator 16 can be fixed to a stator part 19e of the propulsion system 1.

In order to improve the propulsive efficiency of the propulsion system 1, the pressure ratio of the fan section 2, which corresponds to the ratio between the average pressure at the outlet of the stator 16 (or, in the absence of a stator 16, of the rotor 9) and the average pressure at the inlet of the rotor 9, is less than or equal to 1.70, preferably less than or equal to 1.50, for example greater than or equal to 1.01 and less than or equal to 1.45. The average pressures are measured over the height of at least one of the blades 14 of the rotor 9, that is to say the surface that delimits radially inwards the flowpath at the inlet of the rotor 9 to the tip 21 of the blade 14.

In the case of a ducted fan section 2, the fan section 2 comprises a fan casing 12, centered on the longitudinal axis X, and the rotor 9 is housed in the fan casing 12. A ducted fan section 2 comprises a rotor 9 extending upstream of a stator 16. The vanes 17 of the stator 16 are then generally called “Outlet Guide Vanes” (or “OGV”) and have a fixed setting relative to the hub of the stator 16. When the fan section 2 is ducted, the peripheral speed at the tip 21 of the blades 14 of the rotor 9 can be greater than or equal to 260 m·s⁻¹ and less than or equal to 400 m·s⁻¹. Furthermore, the pressure ratio of the fan section 2 can be greater than or equal to 1.20 and less than or equal to 1.45. Finally, the diameter D of the rotor 9 is preferably greater than or equal to 85 inches (215.9 cm) and less than or equal to 120 inches (304.8 cm), for example on the order of 90 inches (228.6 cm), which allows the integration of the propulsion system 1 in a conventional manner, particularly under a wing of the airframe of the aircraft 100.

In the case of an unducted fan section 2, the fan section 2, which can also be referred to as “propeller”, is not surrounded by a fan casing. The blades 14 of the rotor 9 further have a variable setting. Propulsion systems 1 comprising at least one unducted rotor 9 are known as “open rotor” or “unducted fan”. The propulsion system 1 may comprise two unducted and contra-rotating rotors 9. Such a propulsion system 1 is known by the acronym “CROR” for “Contra-Rotating Open Rotor” or “UDF” for “Unducted Double Fan”. The rotors 9 may be placed downstream of the generator 3 so as to be of the pusher type, or at the front of the generator 3 so as to be of the tractor type. As a variant, the propulsion system 1 may comprise a single unducted rotor 9 and an unducted stator 16 (straightener). Such a propulsion system 1 is known by the acronym “USF” for “Unducted Single Fan”. In the case of a USF-type propulsion system 1, the vanes 17 of the straightener 16 are fixed relative to the stator part 19e of the propulsion system 1 and, consequently, do not undergo centrifugal force. The vanes 17 of the straightener 16 are moreover variable-setting vanes. When the fan section 2 is unducted, the peripheral speed at the tip 21 of the blades 14 of the rotor(s) 9 can be greater than or equal to 210 m·s⁻¹ and less than or equal to 260 m·s¹. Furthermore, the pressure ratio of the fan section 2 can be greater than or equal to 1.01 and less than or equal to 1.20. Finally, the diameter D of the rotor 9 is preferably greater than or equal to 100 inches (254 cm), for example greater than or equal to 120 inches (304.8 cm) and less than or equal to 180 inches (457.2 cm).

The compressor section 4, 5 comprises a succession of stages each comprising a blade wheel (rotor) 4a, 5a rotating in front of a vane wheel (stator) 4b, 5b. The turbine section 7, 8 also comprises a succession of stages each comprising a vane wheel (stator) 7b, 8b behind which a blade wheel (rotor) 7a, 8a rotates.

In a two-spool propulsion system 1, the compressor section 4, 5 comprises a low-pressure compressor 4 and a high-pressure compressor 5, and the turbine section 7, 8 comprises a high-pressure turbine 7 and a low-pressure turbine 8. The blade wheels 5a of the high-pressure compressor 5 are driven in rotation by the blade wheels 7a of the high-pressure turbine 7 via a high-pressure shaft 10. The blade wheels 4a of the low-pressure compressor 4 and the rotor 9 of the fan section 2 are driven in rotation by the blade wheels 8a of the low-pressure turbine 8 via a low-pressure shaft 11. Thus, the generator 3 comprises a high-pressure body comprising the high-pressure compressor 5, the high-pressure turbine 7 and the high-pressure shaft 10, and a low-pressure body comprising the fan section 2, the low-pressure compressor 4, the low-pressure turbine 8 and the low-pressure shaft 11. The rotational speed of the high-pressure body is greater than the rotational speed of the low-pressure body. The twin-spool propulsion system 1 may in particular comprise a single-stage high-pressure turbine 7 that is to say comprising exactly one stage, or a two-stage high-pressure turbine that is to say comprising exactly two stages, a high-pressure compressor 5 comprising at least eight stages and at most eleven stages, a low-pressure turbine 8 comprising at least three stages and at most seven stages, and a low-pressure compressor 4 comprising at least two stages and at most four stages.

In a three-spool propulsion system 1, the turbine section 7, 8 further comprises an intermediate turbine, positioned between the high-pressure turbine 7 and the low-pressure turbine 8 and whose blade wheels are configured to drive the blade wheels of an intermediate-pressure compressor via an intermediate shaft. The rotor 9 of the fan section 2 on the one hand, and the blade wheels 5a of the high-pressure compressor 5 on the other hand, remain driven by the low-pressure shaft 11 and the high-pressure shaft 10, respectively.

The low-pressure shaft 11 is generally housed, on a segment of its length, in the high-pressure shaft 10 and is coaxial with the high-pressure shaft 10. The low-pressure shaft 11 and the high-pressure shaft 10 may be co-rotating, that is to say driven in the same direction about the longitudinal axis X. as a variant, the low-pressure shaft 11 and the high-pressure shaft 10 are contra-rotating, that is to say driven in opposite directions about the longitudinal axis X. In any case, the high-pressure shaft 10 and the low-pressure shaft 11 each extend along the longitudinal axis X. Where applicable, the intermediate shaft is housed between the high-pressure shaft 10 and the low-pressure shaft 11. The intermediate shaft and the low-pressure shaft 11 may be co-rotating or contra-rotating. The redline speed ω of the low-pressure shaft 11, which corresponds to the absolute maximum speed likely to be encountered by the low-pressure shaft 11, and therefore the blade wheels 4a, 8a of the low-pressure body, during the entire flight (according to the European certification regulation EASA CS-E 740 or to the American certification regulation 14-CFR Part 33.87), is greater than or equal to 2,000 revolutions per minute (209 radians per second) and less than or equal to 30,000 revolutions per minute (3,142 radians per second), for example greater than or equal to 8,500 revolutions per minute (890 radians per second) and less than or equal to 12,000 revolutions per minute (1,267 radians per second), preferably greater than or equal to 9,000 revolutions per minute (942 radians per second) and less than or equal to 11,000 revolutions per minute (1,152 radians per second). The redline speed ω corresponds to the maximum rotational speed when the propulsion system 1 is sound. It is therefore likely to be reached by the low-pressure shaft 11 in flight conditions. This redline speed forms part of the data declared in the engine certification (or type certificate data sheet). Indeed, this rotational speed is commonly used as a reference speed for the dimensioning of the propulsion systems and in some certification tests, such as blade loss or rotor integrity tests. Of course, the high-pressure shaft 10, and therefore the blade wheels 5a, 7a of the high-pressure body, also has a redline speed, set in the same way as for the low-pressure shaft 11, but higher than that of the low-pressure shaft, for example greater than or equal to 8,000 revolutions per minute and less than or equal to 30,000 revolutions per minute.

The generator 3 comprises an exhaust casing 32 which is an annular piece centered on the longitudinal axis X and configured to support in rotation the downstream portion of the low-pressure shaft 11 via one (or more) bearing(s), which are connected to the exhaust casing 32. Thus, the low-pressure turbine 8 is positioned axially between the high-pressure turbine 7, upstream, and the exhaust casing 32, downstream. The generator 3 further comprises an inter-turbine casing 35 which is an annular piece centered on the longitudinal axis X, positioned between the high-pressure turbine 7 (where applicable, the intermediate turbine) and the low-pressure turbine 8, and configured to support in rotation the high-pressure shaft 10 and/or the low-pressure shaft 11 via one (or more) bearing(s), which are connected to the inter-turbine casing 35.

The stator 16 of the fan section 2, the vane wheels 4b, 5b of the compressor section 4, 5, the vane wheels 7b, 8b of the turbine section 7, 8, the stator part 19e of the propulsion system 1, the inter-turbine casing 35, and the exhaust casing 32 are fixed relative to each other and to the mast for fixing the propulsion system 1 to the airframe of the aircraft 100.

The rotor 9 of the fan section 2 can be decoupled from the low-pressure shaft 11 by means of a reduction mechanism 19, placed between the low-pressure shaft 11 and the rotor 9, in order to be able to independently set their respective rotational speed. In this case, the propulsion system 1 further comprises an additional shaft 20 (or fan shaft 20). The low-pressure shaft 11 connects the blade wheels 8a of the low-pressure turbine 8 to an inlet of the reduction mechanism 19 while the fan shaft 20 connects the outlet of the reduction mechanism 19 to the rotor 9 of the fan section 2. The rotor 9 of the fan section 2 is thus driven by the low-pressure shaft 11 via the reduction mechanism 19 and the fan shaft 20 at a rotational speed lower than the rotational speed of the low-pressure turbine 8. This decoupling allows reducing the rotational speed and the pressure ratio of the rotor 9 of the fan section 2 and increasing the power extracted by the low-pressure turbine 8. Indeed, the overall efficiency of the propulsion system 1 is conditioned to the first order by the propulsion efficiency, which is favorably influenced by a minimization of the variation in the kinetic energy of the fluid when passing through the propulsion system 1.

The reduction mechanism 19 may comprise a single-stage or two-stage reduction mechanism. For example, the reduction mechanism 19 may be of the star type and comprise a sun pinion 19a (inlet of the reduction mechanism 19), centered on an axis of rotation of the reduction mechanism 19 generally coincident with the longitudinal axis X and configured to be driven in rotation by the low-pressure shaft 11, a ring gear 19b (outlet of the reduction mechanism 19) coaxial with the sun pinion 19a and configured to drive in rotation the fan shaft 20 about its axis of rotation, also coincident with the longitudinal axis X, and a series of planet gears 19c distributed circumferentially about the axis of rotation of the rotor 9 of the fan section 2, between the sun pinion 19a and the ring gear 19b, each planet gear 19c being meshed internally with the sun pinion 19a and externally with the ring gear 19b. The series of planet gears 19c is mounted on a planet gear carrier 19d which is fixed relative to the stator part 19e of the propulsion system 1. As a variant, the reduction mechanism 19 can be planetary, in which case the ring gear 19b is fixedly mounted on the stator part 19e of the propulsion system 1, and the fan shaft 20 is driven in rotation by the planet gear carrier 19d. Regardless of the configuration of the reduction mechanism 19, the diameters of the ring gear 19b and of the planet gear carrier 19d are greater than the diameter of the sun pinion 19a, so that the rotational speed of the rotor 9 of the fan section 2 is lower than the rotational speed of the low-pressure shaft 11. The reduction ratio of the reduction mechanism 19 can be greater than or equal to 2.5 and less than or equal to 11. When the fan section 2 is ducted, the reduction ratio can be greater than or equal to 2.7 and less than or equal to 3.5, typically around 3.0. When the fan section 2 is unducted, the reduction ratio can be greater than or equal to 9.0 and less than or equal to 11.0.

The rotor 9 of the fan section 1 can alternatively be directly coupled to the low-pressure shaft 11 (or direct-drive), that is to say without a reduction mechanism 19. The low-pressure shaft 11 is then coincident with the fan shaft 20 so that the rotor 9 is driven by the low-pressure shaft 11 at the same rotational speed as that of the blade wheels 8a of the low-pressure turbine 8.

In operation, the air stream F entering the propulsion system 1 is divided, by an annular nozzle 300 of the generator 3, between a primary air stream F1 and a secondary air stream F2, which circulate from upstream to downstream in the propulsion system 1.

The primary air stream F1 flows in a primary flowpath 29 defined by the generator 3, by passing successively through the compressor section 4, 5, the combustion chamber 6 where it is mixed with fuel to serve as an oxidizer, and the turbine section 7, 8. The passage of the primary air stream F1 through the turbine section 7, 8 receiving energy from the combustion chamber 6, causes rotation of the blade wheels 7a, 8a of the turbine section 7, 8, which in turn drives in rotation the blade wheels 4a, 5a of the compressor section 4, 5 as well as the rotor 9 of the fan section 2.

The secondary air stream F2, also called “bypass air stream”, flows around the primary body 3. The secondary air stream F2 allows cooling the periphery of the primary body 3 and is used to generate most of the thrust provided by the propulsion system 1. The propulsion system 1 is configured to provide a thrust greater than or equal to 18,000 lbf (80,068 N) and less than or equal to 51,000 lbf (226,859 N), preferably greater than or equal to 20,000 lbf (88,964 N) and less than or equal to 35,000 lbf (155,688 N).

The overall pressure ratio (OPR) of the propulsion system 1 is defined as a ratio between the pressure of the primary stream F1 at the outlet of the compressor section 4, 5 and the pressure of the primary stream F1 at the inlet of the compressor section 4, 5.

The bypass ratio of the propulsion system 1 is defined as a ratio between the mass flow rate of the secondary stream F2 and the mass flow rate of the primary stream F1. In order to improve the propulsive efficiency of the propulsion system 1 and reduce its specific fuel consumption as well as the noise emitted by the fan section 2, the propulsion system 1 has a high bypass ratio, that is to say a bypass ratio greater than or equal to 1 and less than or equal to 100, for example greater than or equal to 10 and less than or equal to 80. Indeed, in a propulsion system 1 with a high bypass ratio, most of the flow rate generating the propulsive force is constituted by the secondary stream F2 of the propulsion system 1, the kinetic energy of the secondary stream F2 being mainly affected by the compression that the secondary stream F2 undergoes when passing through the fan section 2. The propulsive efficiency and the pressure ratio of the fan section 2 are therefore linked: the lower the pressure ratio of the fan section 2, the better the propulsive efficiency. When the fan section 2 is ducted, the bypass ratio is preferably greater than or equal to 10, for example greater than or equal to 10 and less than or equal to 35, preferably greater than or equal to 10 and less than or equal to 18. When the fan section 2 is unducted, the removal of the fairing around the fan section 2 allows increasing the bypass ratio significantly without the propulsion system 1 being penalized by the mass of the casings 12 or nacelles intended to surround the fan section 2. In this respect, the bypass ratio is thus greater than or equal to 35, for example greater than or equal to 35 and less than or equal to 80.

The temperature of the exhaust gases (or EGT temperature or EGT redline) is the temperature of the fluid at the outlet of the combustion chamber 6 when the aeronautical propulsion system 1 is operating at maximum continuous power or maximum stabilized power, according to the European certification regulation EASA CS-E 740 (or according to the American certification regulation 14-CFR Part 33). The EGT temperature forms part of the data declared in the certification manual of the aeronautical propulsion system (or type certificate data sheet). To estimate it, the maximum permissible indicated low-pressure turbine temperature T 8 should be used at maximum continuous power or maximum stabilized power.

Each blade wheel 7a, 8a of the turbine section 7, 8 comprises a disk 30 and a plurality of blades 31. Furthermore, the blade wheels 8a of the low-pressure turbine 8 are connected together by means of a plurality of shrouds connecting the disks 30 of the blade wheels 8a in pairs. The same applies to the blade wheels 7a of the high-pressure turbine 7 (or of the intermediate turbine, where applicable) when it comprises more than one blade wheel 7a.

The disk 30 is bored. More specifically, the disk 30 has an inner surface delimiting a bore 34 that passes axially through the disk 30. The bore 34 is circular and centered on the longitudinal axis X when the disk 30 is mounted in the propulsion system 1. The low-pressure shaft 11 extends through the bores 34 of the disks 30 of the low-pressure turbine 8 by being fixed to at least one of the disks 30 of the low-pressure turbine 8, so as to be driven in rotation by its blade wheels 8a during the expansion of the hot fluid circulating from the high-pressure turbine 7 (or of the intermediate turbine, where applicable). The high-pressure shaft 10, for its part, extends from the disk 30 of the last rotor wheel 5a of the high-pressure compressor 5 to the disk 30 of the first rotor wheel 7a of the high-pressure turbine 7, so that it can be driven in rotation by the latter during the expansion of the hot fluid circulating from the combustion chamber 6. Similarly, the intermediate shaft extends from the disk 30 of the last rotor wheel of the intermediate pressure compressor to the disk 30 of the first rotor wheel of the intermediate turbine, so as to be driven in rotation by the latter during the expansion of the hot fluid circulating from the high-pressure turbine 7. Furthermore, the disk 30 has an outer surface 37 delimiting a plurality of recesses distributed about the longitudinal axis X and extending axially. Each of the recesses is configured to ensure fixing, removably or non-removably, one of the blades 31 on the disk 30. In this respect, each recess is open on the primary flowpath 29 when the disk 30 is mounted in the propulsion system 1 and can have any shape, typically a dovetail or fir-tree shape, suitable for fixing the blades 31 with at least one or even several lobe(s).

Each of the blades 31 comprises a base 40 mounted in a recess that opens out at the outer periphery of the disk 30, the base being held in the recess by cooperation with the recess, a strut 41 being connected to the base 40 and comprising a platform 42 delimiting a radially inner portion of the primary flowpath 29, an airfoil 43 connected to the platform 42 and extending within the primary flowpath 29. The airfoil 43 has an aerodynamic profile and has, in this respect, a leading edge 44 that the hot fluid first strikes upon encountering the blade wheel 7a, 8a, a trailing edge 45 axially opposite to the leading edge 44, and a free end (or tip) 46 radially opposite to the platform 42. The airfoil 43 interacts with the hot fluid flowing within the primary flowpath 29 to drive the disk 30 in rotation about the longitudinal axis X. To do so, the airfoil 43 extends within the primary flowpath 29 with a certain incidence relative to the main direction of flow of the fluid. The blade 31 may further comprise a root 47, extending from the free end 46 of the airfoil 43, by being fixed removably or non-removably, or by being integral with the airfoil 43. The root 47 delimits a portion of the primary flowpath 29 with the platform 42 and ensures the sealing of the primary flowpath 29 by limiting hot fluid leaks at the interface between each blade wheel 7a, 8a and a casing 50 of the low-pressure turbine 8 (or of the high-pressure turbine 7, or of the intermediate turbine, where applicable), to which the vane wheels 7b, 8b are fixed. Furthermore, the root 47 improves the vibration behavior of the blades 31. In this respect, the root 47 carries sealing wipers intended to cooperate with an abradable element 51 extending from the casing 50. Where applicable, the tip 46 of the blade 31 corresponds to the radially outer end of the sealing wipers. More specifically, the abradable element 51 is configured to be consumed in case of contact with the tip 46 of the blade 31 during the operation of the propulsion system 1, without the risk of damaging the casing 50. This eliminates the need for clearance between the tip 46 of the blade 31, thus limiting the leaks at the interface between the casing 50 and the blade wheels 8a, and thus improving the performance of the low-pressure turbine 8. Moreover, the abradable element 41 ensures thermal protection to the casing 50 given the high temperatures of the fluid circulating within the primary flowpath 29.

The casing 50 is a revolution element extending about the longitudinal axis X and may comprise a plurality of sections fixed to each other. The casing 50 may comprise frustoconical portions and/or annular portions. The casing 50 is fixed relative to the stator part 19e of the propulsion system 1. The abradable element 51 is fixed to the casing 50. The abradable element 51 is further arranged in line with and at a distance from the tip 46 of at least one of the blades 31. Preferably, the abradable element 51 is a revolution element, typically annular element, and extends all around the longitudinal axis X by being arranged in line with and at a distance from each of the blades 31.

The aeronautical propulsion system 1 is such that the relation (A), the relation (B) and/or the relation (C), described below, is/are met. The verification of this (these) relation(s) can be ensured following a method for manufacturing the aeronautical propulsion system that comprises a step of dimensioning the high-pressure turbine 7, a step of dimensioning the low-pressure turbine 8 and/or a step of dimensioning the intermediate turbine, such that the relation (A), the relation (B) and/or the relation (C), described below, is (are) met.

The relation (A) is as follows:

$$α \leq \frac{S * {T}^{4}}{Z * 1 {0}^{6}} \leq β$$

In the relation (A), a is equal to 5,700 m²·K⁴. Furthermore, S is an outlet section of the low-pressure turbine 8 which is defined as an area of an outlet surface taken in a plane orthogonal to the longitudinal axis X which is positioned at an equal distance from the leading edge 44 and from the trailing edge 45 of a airfoil 43 of the blade wheel 8a of the low-pressure turbine 8 which faces the exhaust casing 32 (i.e., the last of the blade wheels 8a of the low-pressure turbine 8, in the direction of circulation of the primary stream F1 when the propulsion system 1 is in operation), upstream of the latter, by axially facing it. This outlet surface is radially delimited, on the one hand, by the annular surface defined by the set of inner surfaces of the roots 47 of the blades 31 of the blade wheels 8a of the low-pressure turbine 8 facing the exhaust casing 32 and, on the other hand, by the platforms 42 of the blade wheel 8a of the low-pressure turbine 8 facing the exhaust casing 32, by axially facing it. Moreover, S is greater than or equal to 0.35 m² and less than or equal to 0.60 m². T is the maximum permissible Indicated low pressure turbine temperature at maximum continuous power or maximum stabilized power. T is measured in a plane P orthogonal to the longitudinal axis X which comprises the leading edge 44 of an airfoil 43 of the blade wheel 8a of the low-pressure turbine 8 facing the high-pressure turbine 7 (where applicable, facing the intermediate turbine), downstream of the latter, by axially facing it (i.e., the first of the blade wheels 8a of the low-pressure turbine 8, in the direction of circulation of the primary stream F1 when the propulsion system is operating). T is greater than or equal to 1,223 K and less than or equal to 1,473 K. Z is the total number of blades 31 of the plurality of blade wheels 8a of the low-pressure turbine 8, Z being greater than or equal to 150 and less than or equal to 300. Finally, β is equal to 7,000 m²·K⁴.

The relation (B) is as follows:

$$γ \leq \frac{S * {T}^{4}}{N * {R}_{m}^{2} * 1 {0}^{9}} \leq δ$$

In the relation (B), γ is equal to 2,600 K⁴. Furthermore, N is the number of blade wheels 8a of the low-pressure turbine 8, N being greater than or equal to 2 and less than or equal to 5. Finally,

$${R}_{m} = {\sum }_{i = 1}^{N} \frac{{R}_{i}}{N}$$

where R₁ is an outer radius of the i^{th} blade wheels 8a of the low-pressure turbine 8. Furthermore, Rᵢ is defined in a plane orthogonal to the longitudinal axis X which is positioned equidistant from the leading edge 44 and from the trailing edge 45 of the airfoil 43 of one of the blades 31 of the i^{th} of the blade wheels 8a of the low-pressure turbine 8, Rᵢ being a distance between the longitudinal axis X and the free end 46, 47 of the airfoil 43. Moreover, Rₘ is greater than or equal to 0.2 m and less than or equal to 0.6 m. In addition, S is greater than or equal to 0.35 m² and less than or equal to 0.60 m². Furthermore, T is greater than or equal to 1,223 K and less than or equal to 1,473 K. Finally, δ is equal to 3,500 m²·K⁴.

The relation (C) is as follows:

$$θ \leq \frac{Z}{Y} \leq μ$$

In the relation (C), θ is equal to 1.4. Furthermore, Y is the total number of blades 31 of the blade wheels 7a of the high-pressure turbine 7 (plus, where applicable, the total number of blades 31 of the blade wheels of the intermediate turbine). In other words, Y is the total number of blades 31 of the blade wheels of the turbine section 7, 8 excluding the low-pressure turbine 8. Moreover, Y is greater than or equal to 80 and less than or equal to 180. Furthermore, Z is greater than or equal to 150 and less than or equal to 300. Finally, μ is equal to 2.5.

One way to dimension the turbine section 7, 8 so as to verify the relation (A), the relation (B) and/or the relation (C) is to provide for the possibility of increasing its operating rpm. Furthermore, in order to improve the mechanical strength of the airfoils 43 of the blades 31 of the turbine section 7, 8, it is possible to provide for an increase in a ratio between a chord of the airfoil 43 at its inner end and a chord of the airfoil 43 at its free end 46, 47. In addition, in order in particular to improve the mechanical strength of the roots 47 of the blades 31, which are generally subjected to high bending stresses at their inner end, it is possible to provide for a reduction in an axial dimension of the root 47 at its free end 46, 47. Moreover, in order in particular to improve the mechanical strength of the attachment of the base 40 of the blades 31 to the disk 30, it is possible to provide for an increase in the ratio between a chord of the airfoil 43 at its inner end and a chord of the airfoil 43 at its free end, to reduce the number of lobes of the base 40 and/or to increase the compressing depth of the latter. In other words, it is advantageous to provide that the ability of the airfoils 43, the roots 47 and/or the attachment of the base 40 of the blades to the disk 30 to store and withstand stresses, is improved which allows for example reducing the number of blades 31 per blade wheel 7a, 8a.

Thanks to a configuration of the propulsion system 1 conforming to the relation (A), the relation (B) and/or the relation (C), the production and/or maintenance cost of the propulsion system 1 is significantly improved, while reducing its mass and/or volume. Indeed, the relation (A), the relation (B) and/or the relation (C) allow(s) for a reduction in the volume of the low-pressure turbine 8, which promotes the integration of the aeronautical propulsion system 1 under the wing of the aircraft 1. Furthermore, the arrangements required on the low-pressure turbine 8 to ensure its mechanical integrity, while meeting the relation (A), the relation (B) and/or the relation (C), although they may have a negative impact on the aerodynamic performance of the low-pressure turbine 8, result in a gain in terms of production and/or maintenance costs, and in terms of integration with the aircraft 1, which is much higher.

In fact, the relation (A) allows improving the power density extracted by each of the airfoils 43 of the low-pressure turbine 8 from the primary stream F1 circulating within the primary flowpath 29, without however too much stressing the blades 31. Below the range defined by the relation (A), the production and/or maintenance cost would become prohibitive given the power levels extracted by the low-pressure turbine 8 from the primary stream F1 circulating within the primary flowpath 29. Beyond the range defined by the relation (A), the mechanical stresses within the blades 31 would be too great not to negatively impact the lifespan of the propulsion system 1 and, therefore, its maintenance cost. Moreover, such mechanical stresses would require structural adjustments on the blades 31 which would significantly degrade the efficiency of the low-pressure turbine 8, thus increasing the fuel consumption of the propulsion system 1. Besides, reducing the rpm of the low-pressure turbine body to limit such mechanical stresses would also degrade the efficiency of the low-pressure turbine 8.

Furthermore, the relation (B) allows improving the volumetric power density extracted by the low-pressure turbine 8 from the primary stream F1 circulating within the primary flowpath 29, without too much stressing the blades 31. Below the range defined by the relation (B), the mass of the low-pressure turbine 8 would be too high due to radial dimensioning and/or an excessive number of blade wheels 8a. Above the range defined by the relation (B), the mechanical stresses within the blades 31 and/or their base 40 would be too great not to negatively impact the service life of the propulsion system 1 and, therefore, its maintenance cost. In this regard, it should be noted that the removal cost of a propulsion system 1 is generally significantly higher than the manufacturing cost of the low-pressure turbine 8.

Finally, the relation (C) allows reducing the cost of the low-pressure turbine 8 and reducing its relative part of mass within the turbine section 7, 8, by reducing the number of blades 31 within the low-pressure turbine 8. Below the range defined by the relation (C), the aerodynamic load on each blade 31 would reach unacceptable levels. In fact, if the rpm of the low-pressure body were maintained, the efficiency of the low-pressure turbine 8 would be severely degraded, and if this rpm were increased to restore this efficiency, the mechanical stresses within the blades 31 would be too great not to negatively impact the service life of the propulsion system 1 and, therefore, its maintenance cost. Beyond the range defined by the relation (C), the number of blades 31 of the low-pressure turbine 8 would be such that it would negatively impact the production and/or maintenance cost.

The table below details the properties of a propulsion system known to the state of the art on the one hand, and of an aeronautical propulsion system 1 conforming to the present disclosure. Thanks to the present disclosure, a reduction of more than 30% in the number of blades 31 of the low-pressure turbine 8 can be achieved, with the associated benefits in terms of mass and volume reduction, as well as production and maintenance cost.

| | | | Propulsion system 1 | |
|---|---|---|---|---|
| | Propulsion system known | | conforming to the present | |
| Properties | to the state of the art | | disclosure | |
| Thrust | 124,143N | | 123,520N | |
| Diameter D of the rotor 9 of the | 2.11 | m | 2.11 | m |
| fan section 2 | | | | |
| Bypass ratio | 11 | | 12 | |
| Overall Pressure Ratio | 42 | | 50 | |
| Rpm of the rotor 9 of the fan | 3,497 revolutions/minute | | 2,887 revolutions/minute | |
| section 2 (redline) | | | | |
| Rpm of the high-pressure body | 21,572 revolutions/minute | | 24,258 revolutions/minute | |
| (redline) | | | | |
| Rpm of the low-pressure turbine | 10,192 revolutions/minute | | 11,839 revolutions/minute | |
| (redline) | | | | |
| EGT (redline) | 1,300K | | 1,365K | |
| Number of stages 4a, 4b of the | 2 | | 3 | |
| low-pressure compressor 4 | | | | |
| Number of stages 5a, 5b of the | 10 | | 10 | |
| high-pressure compressor 5 | | | | |
| Number of stages 7a, 7b of the | 2 | | 2 | |
| high-pressure turbine 7 | | | | |
| Number of stages 8a, 8b of the | 4 | | 4 | |
| low-pressure turbine 8 | | | | |
| Number of blades 31 of the first | 68 | | 68 | |
| blade wheel 7a of the high- | | | | |
| pressure turbine 7 | | | | |
| Number of blades 31 of the | 68 | | 68 | |
| second blade wheel 7a of the | | | | |
| high-pressure turbine 7 | | | | |
| Number of blades 31 of the | 136 | | 136 | |
| turbine section: 7, 8 excluding | | | | |
| the low-pressure turbine: 8 | | | | |
| Number of blades 31 within the | 344 | | 192 | |
| low-pressure turbine 8 | | | | |
| Outer radius of the first blade | 346.93 | mm | 297.98 | mm |
| wheels 8a of the low-pressure | | | | |
| turbine 8 | | | | |
| Outer radius of the last blade | 408.07 | mm | 369.47 | mm |
| wheel 8a of the low-pressure | | | | |
| turbine 8 | | | | |
| Average of the outer radii of the | 377.5 | mm | 333.73 | mm |
| blade wheels 8a of the low- | | | | |
| pressure turbine 8 | | | | |
| Outlet section of the low- | 0.39 | | 0.36 | |
| pressure turbine 8 | | | | |
| $\frac{S * {T}^{4}}{Z * 1 {0}^{6}}$ | 3,244 | m² · K⁴ | 6,541 | m² · K⁴ |

| | | |
|---|---|---|
| $\frac{S * {T}^{4}}{N * {R}_{m}^{2} * {10}^{9}}$ | 1,958K⁴ | 2,819K⁴ |
| Z/Y | 2.53 | 1.41 |

1-8. (canceled)

9. An assembly of an aeronautical propulsion system, wherein the assembly comprises:
a low-pressure turbine comprising:
an annular low-pressure turbine casing centered on a longitudinal axis; and
a plurality of low-pressure turbine rotor wheels, wherein each of the plurality of low-pressure turbine rotor wheels comprises:
a low-pressure turbine disk centered on the longitudinal axis; and
a plurality of low-pressure turbine blades, each of the plurality of low-pressure turbine blades extending radially between the low-pressure turbine disk and the annular low-pressure turbine casing and comprising:
a base connected to the low-pressure turbine disk and extending radially with respect to a periphery of the low-pressure turbine disk;
a platform extending transversely to the base; and
an airfoil extending radially from the platform to a free end radially opposite to the base, wherein the free end comprises a root that has an inner surface delimiting, with the platform, a portion of a flowpath, wherein the airfoil extends in the flowpath and has a leading edge intended to face a fluid circulating within the flowpath, and a trailing edge axially opposite to the leading edge;
a high-pressure turbine comprising at least one high-pressure turbine rotor wheel configured to drive in rotation at least one high-pressure compressor rotor wheel of a high-pressure compressor;
an exhaust casing configured to support in rotation a downstream portion of a low-pressure shaft;
wherein the low-pressure turbine is positioned axially between the high-pressure turbine and the exhaust casing; and
wherein the low-pressure turbine disk of each of the plurality of low-pressure turbine rotor wheels is connected to the low-pressure turbine disk of another of the plurality of low-pressure turbine rotor wheels, and a low-pressure turbine driving disk of one of the plurality of low-pressure turbine rotor wheels is configured to drive the plurality of low-pressure turbine rotor wheels and is further configured to drive in rotation a rotor of a fan section; and
wherein
$$γ \leq \frac{S * {T}^{4}}{N * {R}_{m}^{2} * 1 {0}^{9}} \leq δ$$
where:
γ is equal to 2,600 K⁴;
S is an outlet section of the low-pressure turbine defined as an area of an outlet surface taken in a plane orthogonal to the longitudinal axis which is positioned equidistant from the leading edge and from the trailing edge of an airfoil of low-pressure turbine blade of a low-pressure turbine rotor wheel which is disposed axially facing the exhaust casing, the outlet surface being radially delimited, on the one hand, by an annular surface formed by the plurality of inner surfaces of the plurality of roots of the plurality of free ends of the plurality of airfoils of the plurality of low-pressure turbine blades of the low-pressure turbine rotor wheel which is disposed axially facing the exhaust casing and, on the other hand, by another annular surface formed by the plurality of the platforms of the plurality of low-pressure turbine blades of the low-pressure turbine rotor wheel which is disposed axially facing the exhaust casing, S being greater than or equal to 0.35 m² and less than or equal to 0.60 m²;
T is a temperature intended to be reached by a fluid entering the low-pressure turbine when the aeronautical propulsion system is operating at maximum continuous power, T being measured in a plane orthogonal to the longitudinal axis that comprises the leading edge of an airfoil of one of the plurality of low-pressure turbine blades of the one of the plurality of low-pressure turbine rotor wheels which is disposed axially facing the high-pressure turbine, T being greater than or equal to 1,223 K and less than or equal to 1,473 K;
N is a number of the plurality of low-pressure turbine rotor wheels, N being greater than or equal to 2 and less than or equal to 5;
$${R}_{m} = {\sum }_{i = 1}^{N} \frac{{R}_{i}}{N} ,$$
where Rᵢ is an outer radius of an i^{th} of the plurality of low-pressure turbine rotor wheels, Rᵢ being defined in a plane orthogonal to the longitudinal axis which is positioned equidistant from the leading edge and from the trailing edge of the airfoil of one of the plurality of low-pressure turbine blades of the i^{th} of the plurality of low-pressure turbine rotor wheels, Rᵢ being a distance between the longitudinal axis and a free end of the root of the one of the plurality of low-pressure turbine blades of the i^{th} of the plurality of low-pressure turbine rotor wheels, and Rₘ being greater than or equal to 0.2 m and less than or equal to 0.6 m; and
δ is equal to 3,500 m²·K⁴.

10. The assembly of claim 9, wherein:
$$α \leq \frac{S * {T}^{4}}{Z * 1 {0}^{6}} \leq β$$
where:
α is equal to 5,700 m²·K⁴;
Z is a total number of low-pressure turbine blades, Z being greater than or equal to 150 and less than or equal to 300; and
β is equal to 7,000 m²·K⁴.

11. The assembly of claim 9, wherein the high-pressure turbine comprises an annular high-pressure turbine casing centered on the longitudinal axis; and
wherein the at least one high-pressure turbine rotor wheel comprises:
a high-pressure turbine disk centered on the longitudinal axis; and
a plurality of high-pressure turbine blades, each of the plurality of high-pressure turbine blades extending radially between the high-pressure turbine disk and the annular high-pressure turbine casing; and
wherein:
$$θ \leq \frac{Z}{y} \leq μ$$
where:
θ is equal to 1.4;
Z is a total number of low-pressure turbine blades, Z being greater than or equal to 150 and less than or equal to 300;
Y is a total number of high-pressure turbine blades, Y being greater than or equal to 80 and less than or equal to 180; and
μ is equal to 2.5.

12. The assembly of claim 9, further comprising:
a combustion chamber configured to ignite a fluid before the fluid enters the high-pressure turbine; and
a low-pressure shaft extending along the longitudinal axis, connected to the low-pressure turbine driving disk, and configured to drive the rotor of the fan section.

13. An aeronautical propulsion system comprising:
the assembly of claim 9;
a fan section comprising a rotor; a low-pressure shaft connecting the rotor of the fan section to the low-pressure driving disk of the assembly; a high-pressure compressor comprising at least one high-pressure compressor rotor wheel; and a high-pressure shaft connecting the at least one high-pressure compressor rotor wheel to the at least one high-pressure turbine rotor wheel of the high-pressure turbine of the assembly; and a bearing supporting in rotation the low-pressure shaft and connected to the exhaust casing of the assembly.

14. A method wherein an aeronautical propulsion system is manufactured, wherein the aeronautical propulsion system comprises:
a low-pressure turbine comprising:
an annular low-pressure turbine casing centered on a longitudinal axis; and
a plurality of low-pressure turbine rotor wheels, wherein each of the plurality of low-pressure turbine rotor wheels comprises:
a low-pressure turbine disk centered on the longitudinal axis; and
a plurality of low-pressure turbine blades, each of the plurality of low-pressure turbine blades extending radially between the low-pressure turbine disk and the annular low-pressure turbine casing and comprising:
a base connected to the low-pressure turbine disk and extending radially with respect to a periphery of the low-pressure turbine disk;
a platform extending transversely to the base; and
an airfoil extending radially from the platform to a free end radially opposite to the base, wherein the free end comprises a root that has an inner surface delimiting, with the platform, a portion of a flowpath, wherein the airfoil extends in the flowpath and has a leading edge intended to face a fluid circulating within the flowpath, and a trailing edge axially opposite to the leading edge;
a high-pressure turbine comprising at least one high-pressure turbine rotor wheel configured to drive in rotation at least one high-pressure compressor rotor wheel of a high-pressure compressor;
a high-pressure turbine comprising at least one high-pressure turbine rotor wheel configured to drive in rotation at least one high-pressure compressor rotor wheel of a high-pressure compressor;
an exhaust casing configured to support in rotation a downstream portion of a low-pressure shaft;
wherein the low-pressure turbine is positioned axially between the high-pressure turbine and the exhaust casing; and
wherein the low-pressure turbine disk of each of the plurality of low-pressure turbine rotor wheels is connected to the low-pressure turbine disk of another of the plurality of low-pressure turbine rotor wheels, and a low-pressure turbine driving disk of one of the plurality of low-pressure turbine rotor wheels is configured to drive the plurality of low-pressure turbine rotor wheels and is further configured to drive in rotation a rotor of a fan section; and
wherein the method comprises dimensioning the low-pressure turbine such that:
$$γ \leq \frac{S * {T}^{4}}{N * {R}_{m}^{2} * 1 {0}^{9}} \leq δ$$
where:
γ is equal to 2,600 K⁴;
S is an outlet section of the low-pressure turbine defined as an area of an outlet surface taken in a plane orthogonal to the longitudinal axis which is positioned equidistant from the leading edge and from the trailing edge of an airfoil of low-pressure turbine blade of a low-pressure turbine rotor wheel which is disposed axially facing the exhaust casing, the outlet surface being radially delimited, on the one hand, by an annular surface formed by the plurality of inner surfaces of the plurality of roots of the plurality of free ends of the plurality of airfoils of the plurality of low-pressure turbine blades of the low-pressure turbine rotor wheel which is disposed axially facing the exhaust casing and, on the other hand, by another annular surface formed by the plurality of the platforms of the plurality of low-pressure turbine blades of the low-pressure turbine rotor wheel which is disposed axially facing the exhaust casing, S being greater than or equal to 0.35 m² and less than or equal to 0.60 m²;
T is a temperature intended to be reached by a fluid entering the low-pressure turbine when the aeronautical propulsion system is operating at maximum continuous power, T being measured in a plane orthogonal to the longitudinal axis that comprises the leading edge of an airfoil of one of the plurality of low-pressure turbine blades of the one of the plurality of low-pressure turbine rotor wheels which is disposed axially facing the high-pressure turbine, T being greater than or equal to 1,223 K and less than or equal to 1,473 K;
N is a number of the plurality of low-pressure turbine rotor wheels, N being greater than or equal to 2 and less than or equal to 5;
$${R}_{m} = {\sum }_{i = 1}^{N} \frac{{R}_{i}}{N} ,$$
where Rᵢ is an outer radius of an i^{th} of the plurality of low-pressure turbine rotor wheels, Rᵢ being defined in a plane orthogonal to the longitudinal axis which is positioned equidistant from the leading edge and from the trailing edge of the airfoil of one of the plurality of low-pressure turbine blades of the i^{th} of the plurality of low-pressure turbine rotor wheels, Rᵢ being a distance between the longitudinal axis and a free end of the root of the one of the plurality of low-pressure turbine blades of the i^{th} of the plurality of low-pressure turbine rotor wheels, and Rₘ being greater than or equal to 0.2 m and less than or equal to 0.6 m; and
δ is equal to 3,500 m²·K⁴.

15. The method of claim 14, wherein the dimensioning of the low-pressure turbine is further implemented such that:
$$α \leq \frac{S * {T}^{4}}{Z * 1 {0}^{6}} \leq β$$
where:
α is equal to 5,700 m²·K⁴;
Z is a total number of low-pressure turbine blades, Z being greater than or equal to 150 and less than or equal to 300; and
β is equal to 7,000 m²·K⁴.

16. The method of claim 14, wherein the high-pressure turbine comprises an annular high-pressure turbine casing centered on the longitudinal axis; and
wherein the at least one high-pressure turbine rotor wheel comprises:
a high-pressure turbine disk centered on the longitudinal axis; and
a plurality of high-pressure turbine blades, each of the plurality of high-pressure turbine blades extending radially between the high-pressure turbine disk and the annular high-pressure turbine casing; and
wherein the method further comprises dimensioning the high-pressure turbine, wherein the dimensioning of the high-pressure turbine and the dimensioning of the low-pressure turbine are implemented such that:
$$θ \leq \frac{Z}{Y} \leq μ$$
where:
θ is equal to 1.4;
Z is a total number of low-pressure turbine blades, Z being greater than or equal to 150 and less than or equal to 300;
Y is a total number of high-pressure turbine blades, Y being greater than or equal to 80 and less than or equal to 180; and
μ is equal to 2.5.
